(19) United States
(12) Patent Application Publication
(10) Pub. No.: US 2012/0144939 A1
(43) Pub. Date: Jun. 14, 2012

(54) Double Bearing Assembly for Rotating Shaft

(76) Inventors: Arne Lars Jonas Kullin, Ann Arbor, MI (US); Janice Duffy, Farmington, MI (US)

(21) Appl. No.: 12/966,463

(22) Filed: Dec. 13, 2010

(51) Int. Cl. F16H 25/08; F16C 19/18

(52) U.S. Cl. 74/25; 384/517

(57) ABSTRACT

A double bearing assembly is for supporting a rotatable shaft within a housing and includes two axially-spaced inner races mounted on the shaft. Each inner race has an outer race surface with a radially-outwardly extending shoulder section adjacent one axial end and are arranged such that the two shoulder surfaces are facing. Two axially-spaced outer races are disposed within the housing, each about one of the inner races. Each outer race has an inner race surface with a radially-inwardly extending shoulder section adjacent one end and are arranged such that the two shoulder surfaces face away from each other. A set of rolling element are disposed between each pair of races. At least one biasing member biases one of the outer races axially to retain the associated rolling elements sandwiched between the inner shoulder surface of the outer race and the outer shoulder surface of the corresponding inner race.

The present invention relates to bearings, and more particularly to double bearing assemblies for supporting rotating shafts.

Rotary actuators, such as actuators used to rotate X-ray anodes, are often formed with two bearings to support a central rotating shaft. Although such known “double bearing” assemblies have generally acceptable performance, it would be desirable to improve the capability of the actuator to react to various loading conditions.

### SUMMARY OF THE INVENTION

In one aspect, the present invention is a double bearing assembly for supporting a shaft within a bore of a housing, the shaft being rotatable about a central axis. The bearing assembly comprises first and second inner race members mounted on the shaft so as to be spaced apart along the axis, each inner race member having opposing axial ends and an outer raceway surface with a radially-outwardly extending shoulder section proximal to one axial end. The two inner race members are arranged such that the outer shoulder surface section of each inner race member generally faces the shoulder surface section of the other inner race member. First and second outer race members are disposed within the housing so as to be axially displaceable within the bore and disposed generally about a corresponding one of the first and second inner race members, each outer race member having opposing axial ends and an inner raceway surface with a radially-inwardly extending shoulder section proximal to one axial end. The two outer race members are arranged such that the inner shoulder surface section of each outer race member faces generally away from the shoulder surface section of the other outer race member. First and second sets of rolling elements, the first set of rolling elements are disposed between the first inner and outer race members to provide a first bearing and the second set of rolling elements being disposed between the second inner and outer race members to provide a second bearing. Further, at least one biasing member is configured to generally bias one of the first and second outer race members generally axially so as to retain the proximal one of the first and second sets of rolling elements sandwiched between the inner shoulder surface section of the one outer race member and the outer shoulder surface section of the corresponding inner race member.

In another aspect, the present invention is a rotary actuator assembly comprising a shaft rotatable about a central axis, a housing having a bore, and a double bearing assembly as described in the preceding paragraph.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of a rotating actuator with a double-bearing assembly in accordance with the present invention, shown with two disk spring biasing members;

FIG. 2 is an axial cross-sectional view of the rotating actuator with the double-bearing assembly, shown with two coil spring biasing members;

FIG. 3 in an axial cross-sectional view of the rotating actuator with the double-bearing assembly, shown with a single coil spring biasing member;

FIG. 4 is an axial cross-sectional view of the rotating actuator of FIG. 2, depicting axial loading on the housing in a first direction;

FIG. 5 is an axial cross-sectional view of the rotating actuator of FIG. 2, depicting axial loading on the housing in a second, opposing direction;

FIG. 6 is an axial cross-sectional view of the rotating actuator of FIG. 2, depicting thermal expansion of the housing;

FIG. 7 is a broken-away, axial cross-sectional view of the shaft and inner race members of the rotating actuator; and

FIG. 8 is a broken-away, axial cross-sectional view of the housing and outer race members of the rotating actuator.

### DETAILED DESCRIPTION OF THE INVENTION

Certain terminology is used in the following description for convenience only and is not limiting. The words “right”, left”, “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

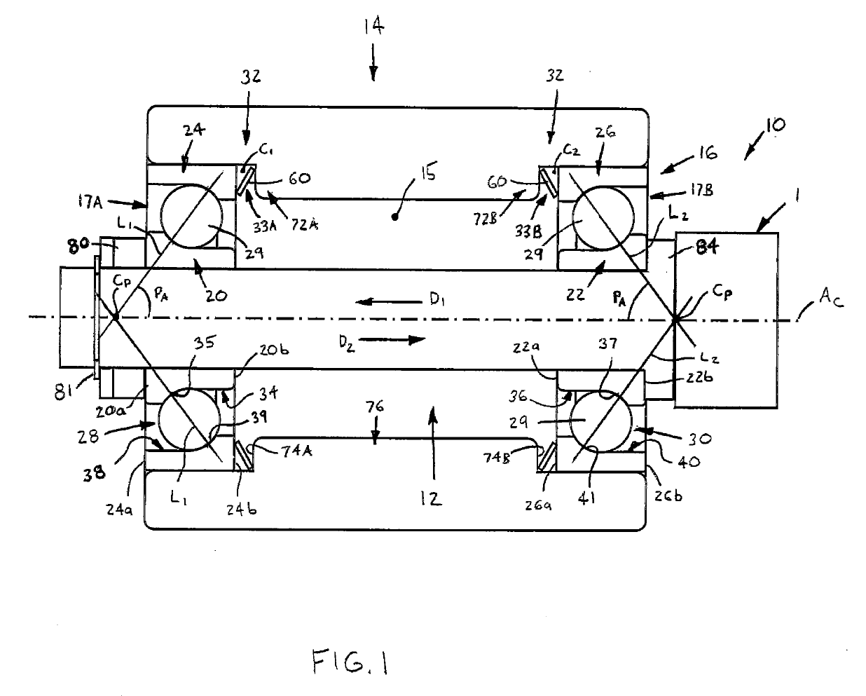

Referring now to the drawings in detail, wherein like numbers are used to indicate like elements throughout, there is shown in FIGS. 1-8 a rotary actuator assembly 10 comprising a shaft 12 rotatable about a central axis A_{C}, a housing 14 having a bore 15, and a double bearing assembly 16 configured to support the shaft 12 within the housing 14. Preferably, the actuator assembly 10 is utilized in an X-ray machine, with the shaft 12 configured to receive an X-ray anode 1 such that rotation of the shaft 12 rotates the anode 1 generally about the central axis A_{C}, but the actuator assembly 10 may be used in any other appropriate application. The double bearing assembly 16 basically comprises first and second inner race members 20, 22 mounted on the shaft 12, first and second outer race members 24, 26, disposed generally about a corresponding one of the first and second inner race members 20, 22, respectively, and first and second sets 28, 30 of rolling elements 29. The first set 28 of rolling elements 29 are disposed between the first inner and outer race members 20, 24 to provide a first bearing 17A and the second set 30 of rolling elements 29 are disposed between the second inner and outer race members 22, 26 to provide a second bearing 17B. Preferably, each of the rolling elements 29 is a generally spherical ball, but may be formed in any other appropriate manner. Further, one or more biasing members 32 are each configured to generally bias one of the first and second outer race members 24 or 26 generally axially to establish a “preload” within the associated bearing 17A or 17B, as described in further detail below.

Referring to FIGS. 1-7, the two inner race members 20, 22 are disposed on the shaft 12 so as to be spaced apart along the axis A_{C}, each inner race member 20, 22 having opposing axial ends 20a, 20b and 22a, 22b and an outer raceway surface 34, 36, respectively. Each raceway surface 34, 36 has a radially-outwardly extending shoulder section 35, 37, respectively, proximal to one axial end 20a and 22b of the race member 20, 22, respectively. Further, the two inner race members 20, 22 are arranged on the shaft 12 such that the outer shoulder surface section 35, 37 of each inner race member 20, 22 generally faces the shoulder surface section 37, 35 of the other inner race member 22, 20, as best shown in FIG. 7.

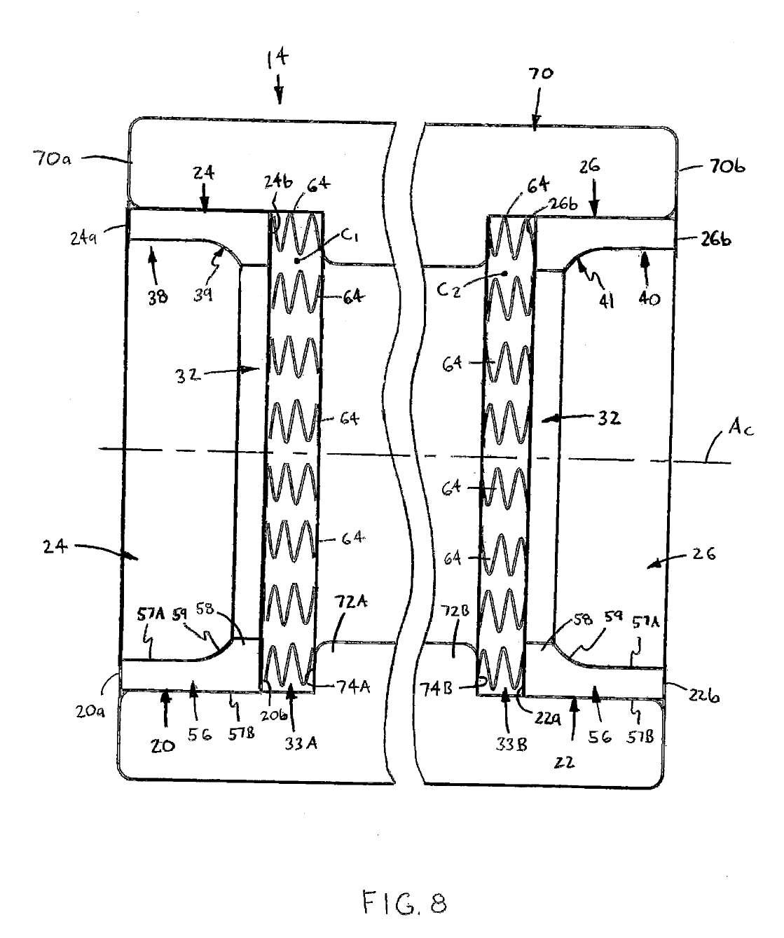

Referring to FIGS. 1-6 and 8, the first and second outer race members 24, 26 are disposed within the housing 14 so as to be axially displaceable within the bore 15. Specifically, each outer race member 24, 26 is not coupled with the housing 14, but rather merely slidably retained therein to enable axial displacement or adjustment of at least one race member 24, 26 as discussed in detail below. Each one of the outer race members 24, 26 has opposing axial ends 24a, 24b and 26a, 26b and an inner raceway surface 38, 40, respectively. Further, each raceway surface 38, 40 has a radially-inwardly extending shoulder section 39, 41, respectively, proximal to one axial end 24b, 26a, respectively, as best shown in FIG. 8. The two outer race members 24, 26 are arranged such that the inner shoulder surface section 39, 41 of each outer race member 24, 26 faces generally away from the shoulder surface section 41, 39 of the other outer race member 26, 24.

Referring specifically to FIG. 1, when arranged as described above, each set of rolling elements 28, 30 is contacted by the associated pair of inner and outer race members 20/24 and 22/26 along a lines of pressure L₁, L₂ respectively, that define acute angles P_{A} with respect to the central axis A_{C}, i.e., as opposed to substantially perpendicular lines of pressure in a conventional ball bearing (none shown). As such, each of the first and second bearings 17A, 17B is generally of a type referred to an “angular contact” bearing. Further, the two bearings 17A are preferably arranged in a diamond or “O” arrangement in which the center of pressure C_{P} of each bearing 17A, 17B is located on the central axis A_{C} “outboard” of the bearings 17A, 17B, i.e., on the side of the bearing 17A, 17B away from the other bearing 17B, 17A.

Referring to FIGS. 1-6, due to the “angled contact” structure of the angular contact bearings 17A, 17B, each bearing 17A, 17B must have some means for establishing and maintaining a “pre-load” on or within the bearing 17A, 17B in order to ensure that all of the rolling elements 29 in each rolling element set 28, 30 remain in contact with the associated pair of inner and outer raceway surfaces 32/36 and 34/38, respectively. Thus, the double bearing assembly 16 includes at least one biasing member 32 configured to generally bias one of outer race members 24, 26 generally axially so as to retain the proximal or associated set 28, 30 of rolling elements 29 sandwiched between the inner shoulder surface section 39, 41 of the one outer race member 24, 26 and the outer shoulder surface section 35, 37 of the corresponding inner race member 20, 22.

More specifically, in a single biasing member construction shown in FIG. 3, the bearing assembly 16 includes only one biasing member 32 (which may be formed of multiple components), depicted as directly acting on the second bearing 17B and indirectly establishing a preload on the first bearing 17A through a stop surface 54A of the housing 14, as described below. In a preferred “double-spring” construction, the bearing assembly 16 includes two biasing members 33A, 33B, each acting directly on a separate outer race member 24, 26, respectively, as depicted in FIGS. 1, 2 and 4-6.

That is, a first biasing member 33A is configured to generally bias the first outer race member 24 in a first direction D₁ generally along the axis A₁. The biasing of the first outer race member 20 retains the first rolling element set 28 sandwiched between the inner shoulder surface section 39 of the first outer race member 24 and the outer shoulder surface section 33 of the first inner race member 20, thereby establishing a preload within the first bearing 17A. Further, the second biasing member 33B is configured to generally bias the second outer race member 26 in a second, opposing direction D₂ generally along the axis A_{C}. The biasing of the second outer race member 22 retains the second rolling element set 30 sandwiched between the inner shoulder surface section 41 of the second outer race member 26 and the outer shoulder surface section 37 of the second inner race member 22, thus providing a preload within the second bearing 17B.

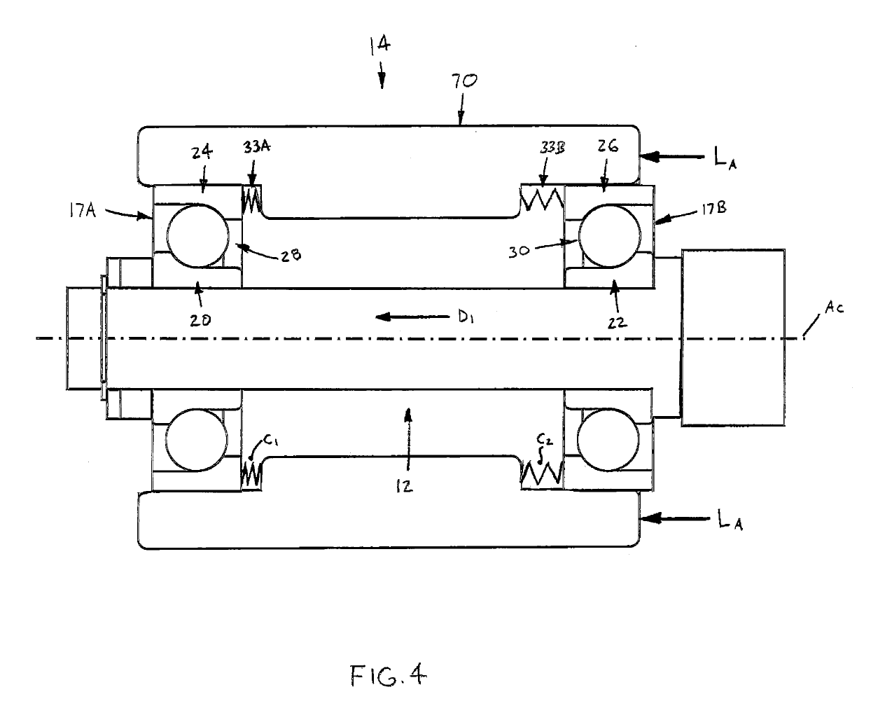

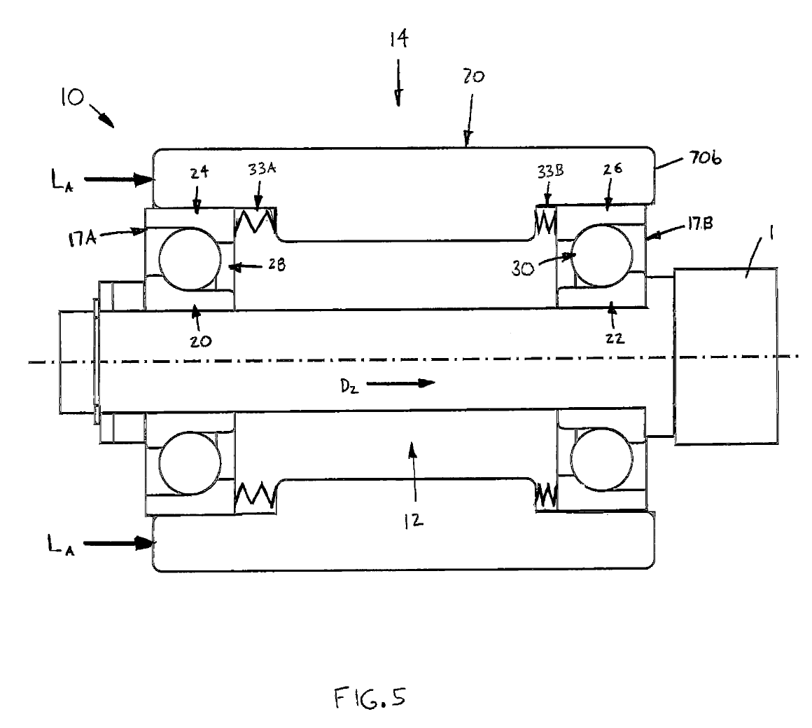

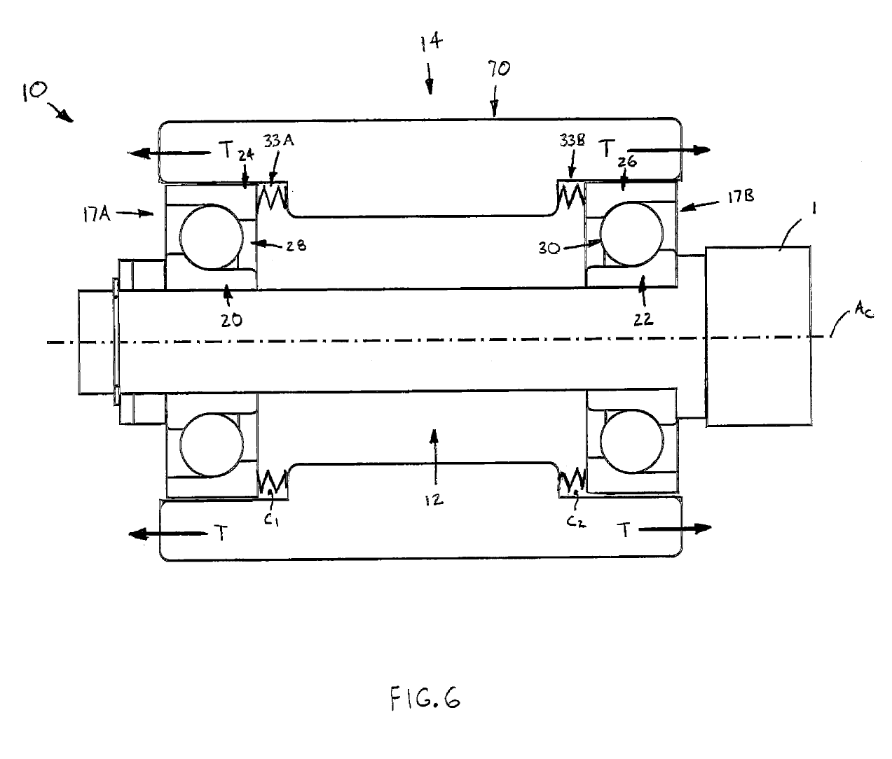

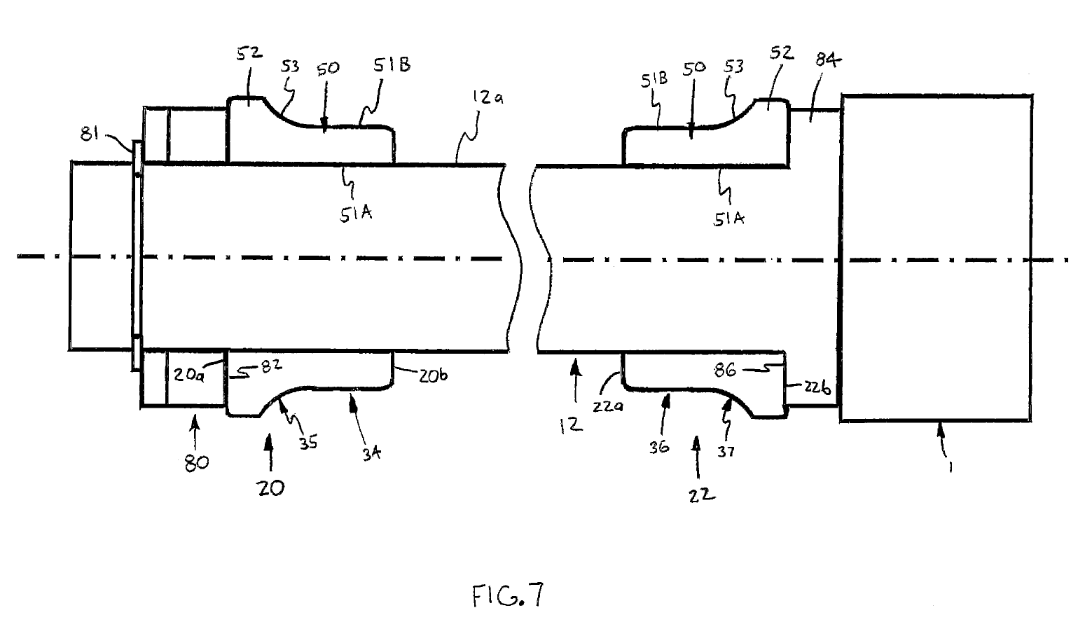

With the preferred double-spring bearing structure, the bearing assembly 16 is capable of reacting to a variety of loading conditions, so as to maintain proper functioning of the actuator 10, as follows. As shown in FIG. 4, when an axial load L_{A} is applied to the housing 14 in the first axial direction D₁, or to the shaft 12 in the second axial direction D₂, the second biasing member 33B expands and the first biasing member 33A compresses in order to maintain the preload within the first and second bearings 17A, 17B, and thus proper contact between the rolling element sets 28, 30 and the associated race member pairs 20/24 and 22/26. Similarly, as depicted in FIG. 5, when an axial load L_{A} is either applied to the housing 14 in the second axial direction, or to the shaft 12 in the first axial direction D₁, the first biasing member 33A expands and the second biasing member 33B compresses such so as to maintain the preload and proper engagement of the bearing components. Further, as shown in FIG. 6, when the housing 14 expands due to thermal loading (indicated by arrows T), each one of the first and second biasing members 33A, 33B compresses as the housing stop surfaces 74A, 74B become displaced toward the bearings 17A, 17B, once again maintaining proper bearing preload. Furthermore, when the shaft 12 expands due to thermal loading (not depicted), each one of the first and second biasing members 33A, 33B expands as the inner race members 20, 22 become displaced away from the stop surfaces 74A, 74B, so as to thereby again maintain bearing preload. Thus, the double bearing assembly 16 has the capability of reacting to a variety of loading conditions while still maintaining proper actuator operation. Having described the basic components and functions above, these and other elements of the present invention are described in further detail below.

Referring first to FIG. 7, each one of the first and second inner race members 20, 22 preferably includes a generally annular body 50 with inner and outer circumferential surfaces 51A, 51B, respectively, and an annular shoulder 52 extending radially outwardly from the outer surface 51B. The inner surface 51A of each inner member body 50 is sized to either engage the shaft outer surface 12a with either an interference fit/“press fit”, so as to retain the particular inner race member 20 or 22 at a fixed position on the shaft 12, or with a clearance fit so as to enable axial displacement. Further, each body 50 has a concave annular surface 53 extending between the outer surface 51B and the shoulder 52 and provides the outer shoulder surface section 35, 37 of the inner race member 20, 22, respectively. As best shown in FIG. 8, each one of the first and second outer race members 24, 26 preferably includes a generally annular body 56 with inner and outer circumferential surfaces 57A, 57B, respectively, and an annular shoulder 58 extending radially inwardly from the inner surface 57A. Preferably, the outer surface 57B of each outer member body 56 is sized to engage the housing bore 15 with a clearance fit, such that the outer race members 24, 26 are axially displaceable or “slidable” within the housing 14. Also, each body 56 has a concave annular surface 59 extending between the inner surface 57 and the shoulder 58 and provides the inner shoulder surface 39, 41 section of the outer race member 24, 26, respectively.

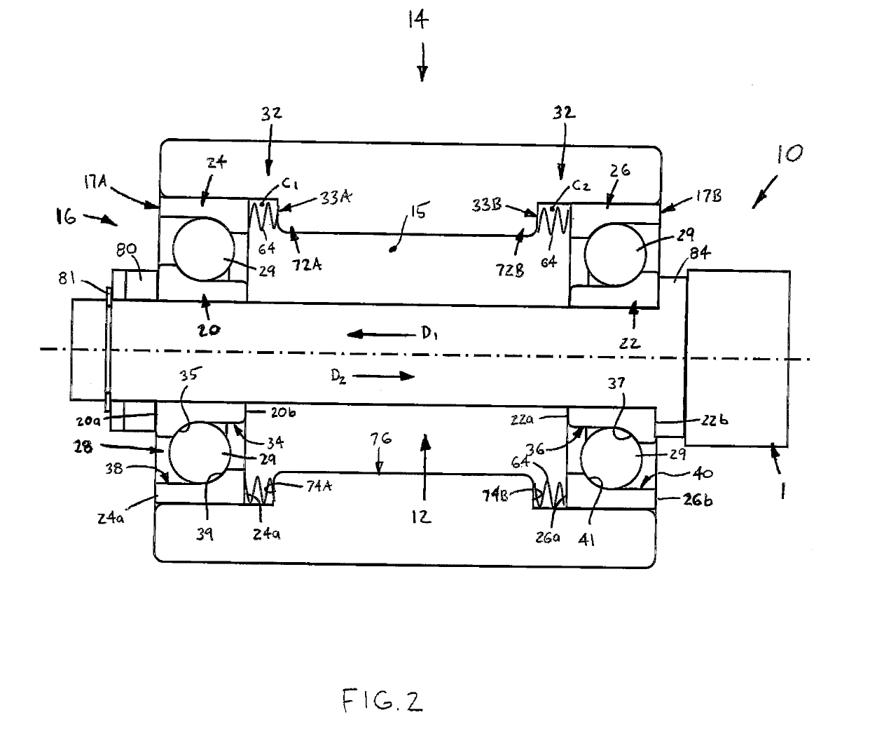

Referring particularly to FIG. 1, each of the one or more biasing members 32 preferably includes a spring washer 60, most preferably a Belleville disk washer as shown, but may be formed as a wave spring washer or any other appropriate type of spring washer. Alternatively, the biasing member(s) 32 may include at least one and preferably a plurality of coil springs 64, as shown in FIGS. 2-6, spaced circumferentially about the central axis A_{C}, but may be formed as a single, larger coil spring (not shown) disposed about the shaft 12. However, the one or more biasing members 32 may be formed in any other appropriate manner, such as for example, a compressible elastomeric ring.

Referring now to FIGS. 1-6 and 8, the housing 14 preferably includes a generally cylindrical body 70 with opposing, first and second axial ends 70a, 70b, the bore 15 extending centrally between the two ends 70a, 70b. Preferably, the housing 14 has first and second stops 72A, 72B, each having a radial surface 74A, 74B and arranged such that each radial stop surface 74A, 54B faces generally away from the other stop surface 74B, 74A and generally toward a proximal axial end 70a or 70b. In a presently preferred construction, the stops 72A, 72B are integrally formed with the housing 14; specifically, the housing body 70 is preferably fabricated with a radially-inwardly stepped central portion or annular shoulder 76. The central shoulder 76 provides both of the first and second stops 72A, 72B, the two stop surfaces 74A, 74B being provided at opposing axial ends of the body central shoulder portion 76. Alternatively, the two stops 72A, 72B may be provided by a pair of annular shoulders or two separate components (e.g., snap rings, etc.) disposed within the housing bore 15 and coupled with the housing 14.

In any case, with the two housing stops 72A, 72B, the preferred bearing assembly 16 with two biasing members 33A, 33B is arranged as follows. The first outer race member 24 is disposed generally between the first stop 72A and the housing first axial end 50a and is spaced from the first stop surface 74A so as to define a first clearance space C₁. The first biasing member 33A is disposed within the first clearance space C₁ and extends generally axially between the first radial stop surface 74A and the first outer race member 24. In a similar but “mirrored” orientation, the second outer race member 26 is disposed generally between the second stop 72B and the housing second axial end 70b and is spaced from the second stop surface 74B so as to define a second clearance space C₂. The second biasing member 33B is disposed within the second clearance space C₂ and extends generally between the second radial stop surface 74B and the second outer race member 26. Thus, the first and second clearance spaces C₁, C₂ enable displacement of the housing 14 relative to the bearings 17A, 17B, either actual displacement/shifting or thermal expansion or contraction, while the biasing members 33A, 33B will compress or extend as necessary to compensate for the displacement(s) of the housing 14.

Further, in the preferred bearing assembly 16 with two biasing members 33A, 33B, the axial dimensions of the two clearance spaces C₁, C₂ are preferably controlled or selected to provide a desired maximum axial displacement of the shaft 12. Specifically, each of the first and second inner race members 20, 22 is preferably disposed at a substantially fixed position with respect to the shaft 12, such that any axial displacement of the shaft 12 must cause a corresponding axial displacement of the outer race members 24, 26. Thus, by properly sizing the axial dimension of each clearance space C₁, C₂, the maximum displacement of the shaft 12 is limited to a desired amount.

Referring specifically to FIG. 3, in the alternative construction having only a single biasing member 32, the first and second outer race members 24, 26 are disposed between the proximal stop surfaces 74A, 74B and the proximal housing ends 70a, 70b as described above with the “double” biasing member construction. However, only the second clearance space C₂ is present, within which is disposed the biasing member 32, while the first outer race member 24 is disposed generally against the housing first stop surface 72A. Thus, the preload on both bearings 17A, 17B is established by the single biasing member 32, which both directly biases the second outer race member 26 in the second axial direction D₂ toward the second inner race member 22 and indirectly biases the first outer race member 24, through the housing central shoulder 76, in the first direction D₁ toward the first inner race member 20. Further, as with the two biasing member structure as described above, the second clearance space C₂ in the single biasing member arrangement of the bearing assembly 16 is preferably sized provide a desired maximum axial displacement of the shaft 12.

Referring now to FIGS. 1-3 and 7, the double bearing assembly 16 preferably further comprises a spacer 80 disposed on the shaft 12 and having a radial surface 82 disposed against an outer end of the first inner race member 20 and the shaft 12 further has an integral shoulder 84 with a radial surface 86 disposed against an outer end of the second inner race member 22. Preferably, the spacer 80 is axially retained in an outward direction (i.e., away from the center of the shaft 12) by a clip 81, but may alternatively be secured by a nut, a key or any other appropriate fixing means. As such, the spacer 80 and the shoulder 84 each function to prevent axial displacement of the associated inner race member 20, 22, respectively.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A double bearing assembly for supporting a shaft within a bore of a housing, the shaft being rotatable about a central axis, the bearing assembly comprising:
first and second inner race members mounted on the shaft so as to be spaced apart along the axis, each inner race member having opposing axial ends and an outer raceway surface with a radially-outwardly extending shoulder section proximal to one axial end, the two inner race members being arranged such that the outer shoulder surface section of each inner race member generally faces the shoulder surface section of the other inner race member;
first and second outer race members disposed within the housing so as to be axially displaceable within the bore and disposed generally about a corresponding one of the first and second inner race members, each outer race member having opposing axial ends and an inner raceway surface with a radially-inwardly extending shoulder section proximal to one axial end, the two outer race members being arranged such that the inner shoulder surface section of each outer race member faces generally away from the shoulder surface section of the other outer race member;
first and second sets of rolling elements, the first set of rolling elements being disposed between the first inner and outer race members to provide a first bearing and the second set of rolling elements being disposed between the second inner and outer race members to provide a second bearing; and
at least one biasing member configured to generally bias one of the first and second outer race members generally axially so as to retain the proximal one of the first and second sets of rolling elements sandwiched between the inner shoulder surface section of the one outer race member and the outer shoulder surface section of the corresponding inner race member.

2. The bearing assembly as recited in claim 1 wherein the at least one biasing member includes:
a first biasing member configured to generally bias the first outer race member in a first direction generally along the axis so as to retain the first set of rolling elements sandwiched between the radially-inwardly extending surface section of the first outer race member and the radially-outwardly extending surface section of the first inner race member and establish a preload within the first bearing;
a second biasing member configured to generally bias the second outer race member in a second, opposing direction generally along the axis so as to retain the second set of rolling elements sandwiched between the radially-inwardly extending surface section of the second outer race member and the radially-outwardly extending surface section of the second inner race member and establish a preload within the second bearing.

3. The bearing assembly as recited in claim 1 wherein the at least one biasing member includes one of a spring washer and at least one coil spring.

4. The bearing assembly as recited in claim 1 further comprising at least one stop with a radial surface, the at least one biasing member extending between the radial stop surface and the one axial end of the one of the first and second outer race members, the stop being one of coupled with the housing and integrally formed with the housing.

5. The bearing assembly as recited in claim 4 wherein each of the first and second inner race members is disposed at a substantially fixed position with respect to the shaft and a clearance space is defined between the at least one stop surface and the proximal one of the first and second outer race members, the clearance space being sized to provide a desired maximum axial displacement of the shaft.

6. The bearing assembly as recited in claim 1 wherein:
each one of the first and second inner race members includes a generally annular body with an outer circumferential surface, an annular shoulder extending radially outwardly from the outer surface, and a concave annular surface extending between the outer surface and the shoulder and providing the outer shoulder surface section of the one inner race member; and
each one of the first and second outer race members includes a generally annular body with an inner circumferential surface, an annular shoulder extending radially inwardly from the inner surface, and a concave annular surface extending between the inner surface and the shoulder and providing the inner shoulder surface section of the one outer race member.

7. A rotary actuator assembly comprising:
a shaft rotatable about a central axis;
a housing having a bore; and
a double bearing assembly configured to support the shaft within the housing and including:
first and second inner race members mounted on the shaft so as to be spaced apart along the axis, each inner race member having opposing axial ends and an outer raceway surface with a radially-outwardly extending shoulder section proximal to one axial end, the two inner race members being arranged such that the outer shoulder surface section of each inner race member generally faces the shoulder surface section of the other inner race member;
first and second outer race members disposed within the housing so as to be axially displaceable within the bore and disposed generally about a corresponding one of the first and second inner race members, each outer race member having opposing axial ends and an inner raceway surface with a radially-inwardly extending shoulder section proximal to one axial end, the two outer race members being arranged such that the inner shoulder surface section of each outer race member faces generally away from the shoulder surface section of the other outer race member;
first and second sets of rolling elements, the first set of rolling elements being disposed between the first inner and outer race members to provide a first bearing and the second set of rolling elements being disposed between the second inner and outer race members to provide a second bearing; and
at least one biasing member configured to generally bias one of the first and second outer race members generally axially so as to retain the proximal one of the first and second sets of rolling elements sandwiched between the inner shoulder surface section of the one outer race member and the outer shoulder surface section of the corresponding inner race member.

8. The actuator assembly as recited in claim 7 wherein the at least one biasing member includes:
a first biasing member configured to generally bias the first outer race member in a first direction generally along the axis and generally toward the first inner race member so as to retain the first set of rolling elements sandwiched between the inner shoulder surface section of the first outer race member and the outer shoulder surface section of the first inner race member and establish a preload within the first bearing;
a second biasing member configured to generally bias the second outer race member in a second, opposing direction generally along the axis and generally toward the second inner race member so as to retain the second set of rolling elements sandwiched between the inner shoulder surface section of the second outer race member and the outer shoulder surface section of the second inner race member and establish a preload within the second bearing.

9. The actuator assembly as recited in claim 8 wherein:
the housing has opposing first and second axial ends and first and second stops each having a radial surface, each of the first and second radial stop surfaces facing generally away from the other stop surface and toward one axial end;
the first outer race member is disposed generally between the first stop and the housing first axial end and is spaced from the first stop surface so as to define a first clearance space;
the second outer race member is disposed generally between the second stop and the housing second axial end and is spaced from the second stop surface so as to define a second clearance space;
the first biasing member is disposed within the first clearance space and extends generally between the first radial stop surface and the first outer race member; and
the second biasing member is disposed within the second clearance space and extends generally between the second radial stop surface and the second outer race member.

10. The actuator assembly as recited in claim 9 wherein:
the first biasing member expands and the second biasing member compresses when an axial load is applied to one of the housing in a first direction along the axis and the shaft in a second, opposing direction along the axis such the preload is maintained within each of the first and second bearings;
the second biasing member expands and the first biasing member compresses when an axial load is applied to one of the housing in the second axial direction and the shaft in the first axial direction such the preload is maintained within each of the first and second bearings;
each one of the first and second biasing members compresses when the housing thermally expands such that the preload is maintained within each of the first and second bearings; and
each one of the first and second biasing members expands when the shaft thermally expands such that the preload is maintained within each of the first and second bearings.

11. The actuator assembly as recited in claim 9 wherein each of the first and second inner race members is disposed at a substantially fixed position with respect to the shaft and each one of the first and second clearance spaces is sized to provide a desired maximum axial displacement of the shaft.

12. The actuator assembly as recited in claim 7 wherein the at least one biasing member includes one of a spring washer and at least one coil spring.

13. The shaft assembly as recited in claim 7 further comprising at least one stop with a radial surface, the at least one biasing member extending between the radial stop surface and the one axial end of the one of the first and second outer race members, the

14. The actuator assembly as recited in claim 13 wherein the stop is one of coupled with the housing and integrally formed with the housing.

15. The actuator assembly as recited in claim 13 wherein each of the first and second inner race members is disposed at a substantially fixed position with respect to the shaft and a clearance space is defined between the at least one stop surface and the proximal one of the first and second outer race members, the clearance space being sized to provide a desired maximum axial displacement of the shaft.

16. The actuator assembly as recited in claim 7 wherein:
each one of the first and second inner race members includes a generally annular body with an outer circumferential surface, an annular shoulder extending radially outwardly from the outer surface, and a concave annular surface extending between the outer surface and the shoulder and providing the outer shoulder surface section of the one inner race member; and
each one of the first and second outer race members includes a generally annular body with an inner circumferential surface, an annular shoulder extending radially inwardly from the inner surface, and a concave annular surface extending between the inner surface and the shoulder and providing the inner shoulder surface section of the one outer race member.

17. The actuator assembly as recited in claim 16 wherein that shaft is a configured to receive an X-ray anode such that rotation of the shaft rotates the anode generally about the central axis.
